(19) United States
(12) Patent Application Publication
(10) Pub. No.: US 2026/0128277 A1
(43) Pub. Date: May 7, 2026

(54) BATTERY CELL

(71) Applicant: SAMSUNG SDI CO., LTD., Yongin-si (KR)

(72) Inventor: JAEWOOK KO, Yongin-si (KR)

(21) Appl. No.: 19/192,541

(22) Filed: Apr. 29, 2025

(30) Foreign Application Priority Data
Nov. 4, 2024 (KR) 10-2024-0154261

(51) Int. Cl. H01M 4/13; H01M 10/0525; H01M 10/058

(52) U.S. Cl. CPC H01M 4/13; H01M 10/0525; H01M 10/058; H01M 2220/20

(57) ABSTRACT

Provided is a battery cell including a first electrode plate, a second electrode plate facing the first electrode plate, a separator positioned between the first electrode plate and the second electrode plate, a case accommodating the first electrode plate, the second electrode plate, and the separator, and an electrolyte provided in the case. The first electrode plate includes a first region and a second region that are spaced apart from each other. A gap into which the electrolyte permeates is formed between the first region and the second region, and a width of the gap is 0.1 mm to 0.5 mm.

### CROSS-REFERENCE TO RELATED APPLICATION

This application is based on and claims priority under 35 USC § 119 to Korean Patent Application No. 10-2024-0154261, filed on Nov. 4, 2024, in the Korean Intellectual Property Office, the disclosure of which is incorporated by reference herein in its entirety.

### BACKGROUND

### 1. Field

The present disclosure relates to a battery cell.

### 2. Description of the Related Art

Secondary batteries are batteries that can be charged and discharged, unlike primary batteries that cannot be recharged. Low-capacity secondary batteries are used in small, portable electronic devices such as smartphones, feature phones, laptops, digital cameras, and camcorders, while large-capacity secondary batteries are widely used as power sources for driving motors in hybrid cars, electric cars, and as power storage batteries. These secondary batteries include an electrode assembly including a first electrode plate and a second electrode plate, a case for accommodating the electrode assembly, and electrode terminals connected to the electrode assembly.

The above-described information disclosed in the background art of this disclosure is only intended to improve understanding of the background of the present disclosure and therefore may include information that does not constitute prior art.

### SUMMARY

The present disclosure provides a battery cell made in a reduced amount of time and having improved performance.

However, the technical problems to be solved by the present disclosure are not limited to the problems described above, and other problems not mentioned may be clearly understood by those skilled in the art from the disclosure.

An embodiment of the present disclosure provides a battery cell including a first electrode plate, a second electrode plate facing the first electrode plate, a separator positioned between the first electrode plate and the second electrode plate, a case accommodating the first electrode plate, the second electrode plate, and the separator, and an electrolyte provided in the case, wherein the first electrode plate includes a first region and a second region spaced apart from each other and a gap into which the electrolyte permeates is formed between the first region and the second region, wherein the width of the first gap is 0.1 mm to 0.5 mm.

In an embodiment, the shape of the second electrode plate is the same as a shape of the first electrode plate rotated by 180°.

In an embodiment, the first region and the second region may each include a non-coated portion.

In an embodiment, the second electrode plate may include a third region and a fourth region spaced apart from each other, and a gap into which the electrolyte permeates may be formed between the third region and the fourth region.

In an embodiment, the first region may include a groove extending from the gap into the first region and the second region may include a groove extending from the gap into the second region.

In an embodiment, the ratio of the width of each of the grooves to the length of a shorter side of the first electrode plate may be 0.125 to 0.375.

In an embodiment, the first gap has a zigzag shape and may extend along a first direction.

In an embodiment, the ratio of the shortest width of the first region along a second direction to the length of the shorter side of the first electrode plate along the second direction perpendicular to the first direction may be 0.125 to 0.375.

In an embodiment, the ratio of a total length of the gap to the length of a longer side of the first electrode plate along the first direction may be 1.1 to 1.5.

In an embodiment, the gap in the first electrode plate and the gap in the second electrode plate may be symmetric to each other with respect to an imaginary line passing through a center of the first electrode plate along the first direction.

Another embodiment of the present disclosure provides a battery cell that includes a first plate including a first region and a second region spaced apart from each other, a second plate facing the first plate and including a third region and a fourth region spaced apart from each other, and a separator positioned between the first electrode plate and the second electrode plate, and a case accommodating the first electrode plate, the second electrode plate, and the separator and an electrolyte, wherein the shape of the second plate may be the same as a shape of the first plate rotated by 180°.

In an embodiment, the electrolyte may permeate through a first gap between the first region and the second region and a second gap between the third region and the fourth region.

In an embodiment, the first gap may extend along a first direction and the second gap may extend along the first direction.

In an embodiment, the first gap may have a zigzag shape.

In an embodiment, the first region and the second region may each include a groove extend from the first gap into the regions.

In an embodiment, the ratio of a total length of the first gap to the length of a longer side of the first electrode plate along the first direction may be 1.1 to 1.5.

In an embodiment, the ratio of a shortest width of the first region along the second direction to the length of a shorter side of the first electrode plate along a second direction perpendicular to the first direction may be 0.125 to 0.375.

In an embodiment, the first region include a groove extending from the first gap into the first region and the second region includes a groove extending from the first gap into the second region, and the ratio of the width of the groove to the length of the shorter side of the first electrode plate may be 0.125 to 0.375.

In an embodiment, the first region and the second region may each include a non-coated portion.

In an embodiment, the width of the first gap may be 0.1 mm to 0.5 mm.

### BRIEF DESCRIPTION OF THE DRAWINGS

The following drawings attached to this specification illustrate preferred embodiments of the present disclosure and, together with the detailed description below, serve to further understand the technical idea of the present disclosure. Therefore, the present disclosure should not be interpreted as being limited to matters described in such drawings in which:

FIG. 1 is a perspective view of a battery cell according to an embodiment of the present disclosure;

FIG. 2 is a cross-sectional view of a section A-A′ of the battery cell depicted in FIG. 1;

FIG. 3 is a cross-sectional view of a cross-section of a first electrode plate of the battery cell depicted in FIG. 1;

FIG. 4 is a cross-sectional view of a cross-section of a second electrode plate of the battery cell depicted in FIG. 1;

FIG. 5 is a cross-sectional view of a cross-section of the first electrode plate of the battery cell depicted in FIG. 1;

FIG. 6 is a cross-sectional view of a cross-section of the first electrode plate of the battery cell depicted in FIG. 1;

FIG. 7 is a cross-sectional view of a cross-section of the second electrode plate of the battery cell depicted in FIG. 1;

FIG. 8 is a cross-sectional view of a cross-section of the first electrode plate of the battery cell depicted in FIG. 1;

FIG. 9 is a perspective view of a battery module including a battery cell according to embodiments of the present disclosure; and

FIG. 10 is a cross-sectional view of a means of transportation including the battery cell according to embodiments of the present disclosure.

### DETAILED DESCRIPTION

Hereinafter, preferred embodiments of the present disclosure will be described in detail with reference to the attached drawings. Prior to this, terms or words used in this specification and claims should not be interpreted as limited to their usual or dictionary meanings but should be interpreted as meanings and concepts that conform to the technical idea of the present disclosure based on the principle that the inventor may appropriately define the concept of the term to explain his or her own invention in the best way. Therefore, the embodiments described in this specification and the configurations illustrated in the drawings are only some of the most preferred embodiments of the present disclosure and do not represent all of the technical ideas of the present disclosure, and it should be understood that there may be various equivalents and modified examples that may replace them at the time of this application.

In addition, when used herein, the words “comprise”, “include”, and/or “comprising”, “including”, specify the presence of stated features, numbers, steps, operations, members, elements and/or groups thereof, but do not exclude the presence or addition of one or more other features, numbers, operations, members, elements and/or groups thereof.

In addition, to aid understanding of the invention, the attached drawings are not drawn to an actual scale and the dimensions of some components may be exaggerated. In addition, the same reference numbers may be assigned to the same components in different embodiments.

Although the terms first, second, or the like are used to describe various components, these components are not limited by these terms. These terms are only used to distinguish one component from another, and unless otherwise stated, it is of course the case that a first component may also be a second component.

Throughout the specification, unless otherwise specifically stated, each component may be singular or plural.

Any configuration being placed “at a top (or at a bottom)” of a component or “on (or below)” a component may mean not only that any configuration is placed in contact with an upper surface (or lower surface) of the component, but also that other configurations may be interposed between the component and any configuration placed on (or below) the component.

In addition, when it is described that components are “coupled,” “bonded,” or “connected” to another component, it should be understood that the components may be directly connected or connected to one another, but that other components may also be “interposed” between each component, or that each component may be “coupled,” “bonded,” or “connected” through other components. In addition, when indicated that a part is electrically coupled to another part, this includes not only cases where they are directly coupled, but also cases where they are coupled to each other with another element in between.

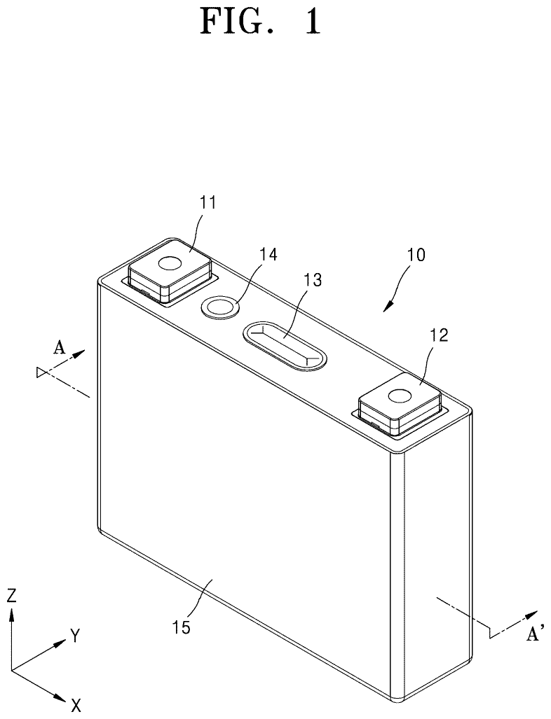

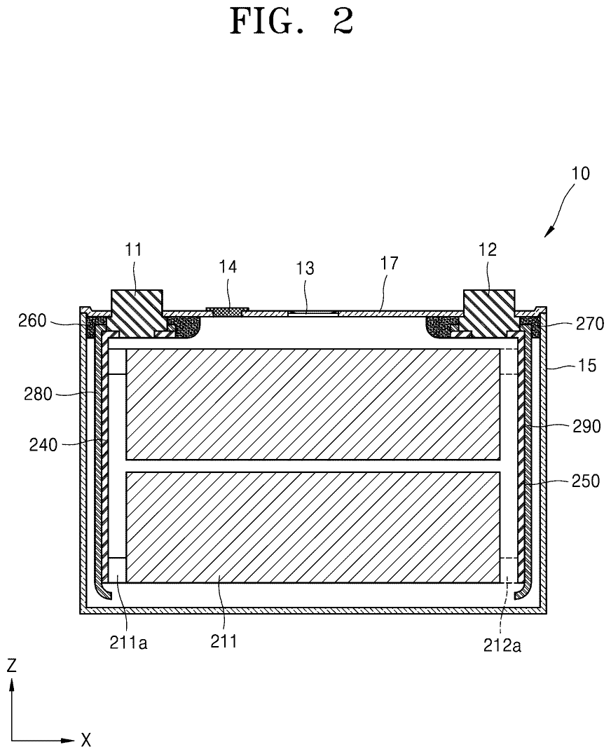

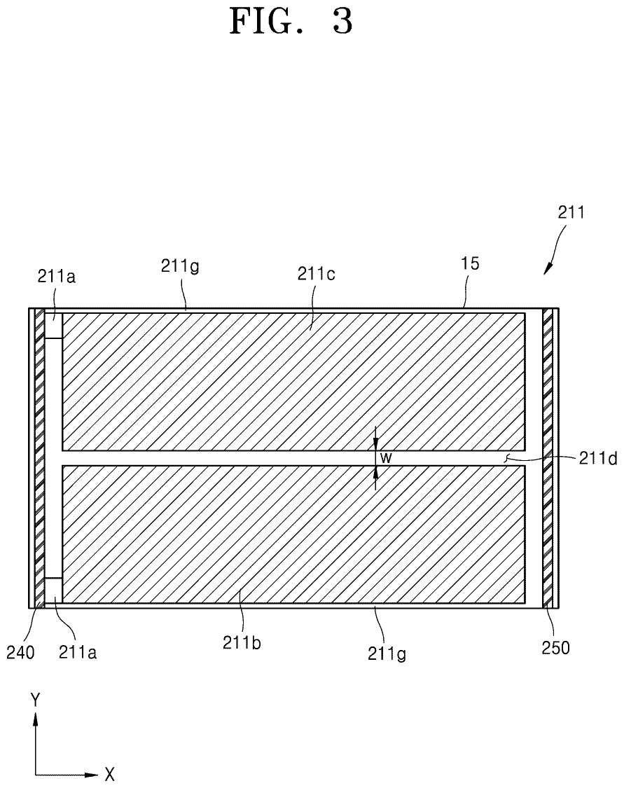

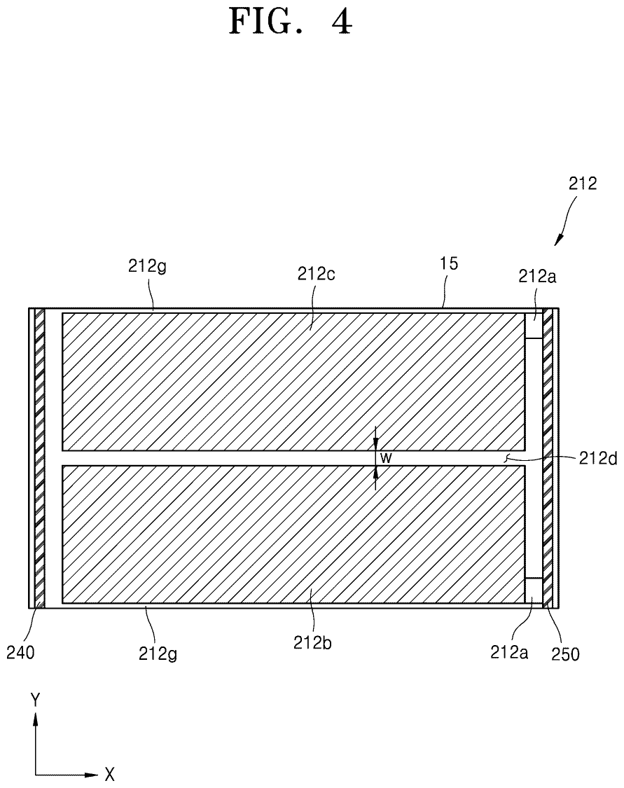

FIG. 1 is a perspective view of a battery cell according to an embodiment of the present disclosure, FIG. 2 is a cross-sectional view schematically illustrating an example of a cross-section A-A′ of the battery cell depicted in FIG. 1, FIG. 3 is a cross-sectional view schematically illustrating an example of a cross-section of a first electrode plate of the battery cell depicted in FIG. 1, and FIG. 4 is a cross-sectional view schematically illustrating an example of a cross-section of a second electrode plate of the battery cell depicted in FIG. 1.

Referring to FIGS. 1 to 4, a battery cell 10 according to an embodiment of the present disclosure may include a first electrode plate 211, a second electrode plate 212 facing the first electrode plate 211, a separator between the first electrode plate 211 and the second electrode plate 212. A case 15 accommodates the first electrode plate 211, the second electrode plate 212, and the separator and an electrolyte.

The first electrode plate 211 and the second electrode plate 212 may include at least one electrode assembly that is alternately laminated along a thickness direction y of the battery cell 10 with the separator in between. However, a lamination direction of the electrode assembly is not limited to the thickness direction y of the battery cell 10, and as another example, the lamination direction of the electrode assembly may be a height direction z of the battery cell 10.

The first electrode plate 211 and the second electrode plate 212 of the battery cell 10 may have different polarities. In some embodiments, if the first electrode plate 211 is a positive electrode, the second electrode plate 212 may be a negative electrode. Conversely, if the first electrode plate 211 is a negative electrode, the second electrode plate 212 may be a positive electrode. That is, the first electrode plate 211 and the second electrode plate 212 are formed with different electrical polarities and are not limited to a specific polarity.

The battery cell 10 according to an embodiment is described as a square lithium ion battery cell as an example. However, the present disclosure is not limited thereto, and the present disclosure may be applied to various types of battery cells such as lithium polymer battery cells or cylindrical battery cells.

The first electrode plate 211 and the second electrode plate 212 may include a coated portion, which is an area where an active material is applied to a current collector formed of a metal foil of a thin plate. The first electrode plate 211 and the second electrode plate 212 may also include a first non-coated portion 211a and a second non-coated portion 212a, which are areas where an active material is not coated.

The electrode assembly may be formed by a structure in which a first electrode plate 211 and a second electrode plate 212 made of a plurality of sheets are alternately laminated with a separator in between. However, the present disclosure is not limited thereto, and the first electrode plate 211 and the second electrode plate 212 may be wound with insulating separators between the electrode plates 211 and 212.

The case 15 forms the outer appearance of the battery cell 10 and may include a conductive metal such as aluminum, an aluminum alloy, or nickel-plated steel. In some embodiments, the case 15 may provide a space in which the electrode assembly is accommodated.

The battery cell 10 may include a cap plate 17 covering an opening of the case 15, and the case 15 and the cap plate 17 may be made of a conductive material. In this regard, a first terminal 11 and a second terminal 12 electrically coupled to the first electrode plate 211 or the second electrode plate 212 may be installed to protrude outward by extending through the cap plate 17. In some embodiments, an outer surface of an upper pillar of the first terminal 11 and the second terminal 12 protruding outward from the cap plate 17 may be threaded and fixed to the cap plate 17 with a nut. However, the present disclosure is not limited thereto, and the first terminal 11 and the second terminal 12 may include a rivet structure and may be riveted or may be welded to the cap plate 17.

In some embodiments, the cap plate 17 may include a thin plate and may be joined to the opening of the case 15, and an electrolyte injection port 14 into which a sealing plug may be installed may be formed in the cap plate 17, and a vent 13 having a notch may be provided in the cap plate 17.

The first terminal 11 and the second terminal 12 may be electrically connected to a current collector including a first current collector 240 and a second current collector 250, which are welded to a first non-coated portion 211a of the first electrode plate and a second non-coated portion 212a of the second electrode plate, respectively. In some embodiments, the first terminal 11 and the second terminal 12 may be welded to the first current collector 240 and the second current collector 250, respectively. However, the present disclosure is not limited thereto, and the first terminal 11 and the second terminal 12 and the first current collector 240 and the second current collector 250 may be formed integrally.

In some embodiments, an insulation member may be provided between the electrode assembly and the cap plate 17. In this regard, the insulation member may include first and second lower insulation members 260 and 270, and each of the first and second lower insulation members 260 and 270 may be provided between the electrode assembly and the cap plate 17.

In addition, according to an embodiment, one end of a separation member that may face one side of the electrode assembly may be positioned between the insulation member and the first terminal 11 and the second terminal 12. In this regard, the separation member may include first and second separation members 280 and 290. Accordingly, one end of the first and second separation members 280 and 290 that may face one side of the electrode assembly may be positioned between the first and second lower insulation members 260 and 270 and the first terminal 11 and the second terminal 12.

The first terminal 11 and the second terminal 12 welded to the first current collector 240 and the second current collector 250 may be joined to one end of the first and second lower insulation members 260 and 270 and the first and second separation members 280 and 290.

In embodiments, the first electrode plate 211 may include a first region 211b and a second region 211c that are spaced apart from each other. That is, in embodiments, a first gap 211d into which an electrolyte permeates may be formed between the first region 211b and the second region 211c.

The second electrode plate 212 may include a third region 212b and a fourth region 212c that are spaced apart from each other. A second gap 212d into which an electrolyte permeates may be formed between the third region 212b and the fourth region 212c.

When the first region 211b, the second region 211c, the third region 212b, and the fourth region 212c are accommodated in the case 15, gaps 211g may be formed between outer side portions of the first region 211b and the second region 211c and the case.. Similarly, gaps 212g may formed between outer side portions of the third region 212b and the fourth region 212c and the case 15. Thus, the electrolyte may permeate into the electrode assembly through the gaps 211g and 212g. That is, the electrolyte may permeate into the electrode assembly by moving through the gaps 211g and 212g between the first and second electrode plates 211 and 212 and the case and through the gaps 211d and gap 212d between the first and second parts of the first and second electrode plates 211 and 212.

Conventionally, a process for injecting an electrolyte into the electrode assembly located inside the case 15 of the battery cell 10 may requires long time because the electrolyte needs to completely permeate into the electrode assembly. However, in embodiments of the present disclosure, when the first electrode plate 211 includes a first gap 211d formed between a first region 211b and a second region 211c that are spaced apart from each other, and the second electrode plate 212 includes a second gap 212d formed between a third region 212b and a fourth region 212c that are spaced apart from each other, an electrolyte may quickly permeate into the electrode assembly through the gaps 211d and gap 212d. Thus, the time required for the electrolyte injection process may be shortened, and production of battery cells such as the battery cell 10 may be increased. Further, the performance of the battery cell 10 may be improved by evenly permeating the electrolyte throughout the overall area of the electrode assembly.

The first region 211b and the second region 211c of the first electrode plate 211 include a first active material. In embodiments where the first electrode plate 211 is an anode, the first active material applied to the first region 211b and the second region 211c may include at least one of lithium cobalt oxide, lithium iron phosphate, lithium nickel manganese cobalt oxide, or lithium nickel cobalt aluminum oxide, although the present disclosure is not limited to these examples. In embodiments, the first region 211b and the second region 211c may each include a first non-coated portion 211a where the first active material is not provided, and the first non-coated portions 211a may each be electrically connected to the first current collector 240.

The third region 212b and the fourth region 212c of the second electrode plate 212 may include a second active material. In some embodiments where the second electrode plate 212 is a cathode, the second active material applied to the third region 212b and the fourth region 212c may include at least one of graphite, silicon, or lithium titanium oxide, although the present disclosure is not limited to these examples. The third region 212b and the fourth region 212c may each include a second non-coated portion 212a where the second active material is not provided, and the second non-coated portions 212a may each be electrically connected to the second current collector 250.

When the first electrode plate 211 includes a first region 211b and a second region 211c that are spaced apart from each other, and the second electrode plate 212 includes the third region 212b and the fourth region 212c that are spaced apart from each other, a first current path may be formed in the first region 211b and the third region 212b that faces the first region 211b, and a second current path may be formed in the second region 211c and the fourth region 212c that faces the second region 211c. In such a case, the first current path and the second current path may be parallel to each other. That is, when the first electrode plate 211 and the second electrode plate 212 each include regions spaced apart from each other, the spaced apart regions may be electrically connected in parallel with each other, and the voltage of each of the spaced apart regions may be the same.

In this way, when the first electrode plate 211 and the second electrode plate 212 each include two non-coated portions 211a and 212a and the spaced apart regions are connected in parallel to each other, a current may flow to the first and second current collectors 240 and 250 through the two non-coated portions 211a and 212a of the spaced apart regions. As compared to a configuration having only one non-coated portion per electrode plate, when there are two non-coated portions 211a and 212a mobility of electrons may be improved and a resistance of the battery cell 10 may be reduced. Thus, a current efficiency of the battery cell 10 may be increased.

As another embodiment, a connection portion connecting the first region 211b and the second region 211c may be provided between the first region 211b and the second region 211c. When a connection portion is provided between the first region 211b and the second region 211c, the first and second regions 211b and 211c are not connected in parallel to each other, and a current may flow through the connection portion between the first region 211b and the second region 211c. By controlling a width of the connection portion to control an electrolyte penetration path, an impregnation property of an electrolyte may be improved. In such a case, the first region 211b and the second region 211c are connected to each other and thus may include only one non-coated portion.

The width w of the first gap 211d and the second gap 212d may be 0.1 mm to 0.5 mm. Because the first gap 211d and the second gap 212d may have the same width, the electrolyte may effectively permeate by capillary action. If the width w of the first gap 211d and the second gap 212d is less than 0.1 mm, a flow rate of the electrolyte permeating into the electrode assembly through the first gap 211d and the second gap 212d may decrease. In such a case, the electrolyte injection process may be not be substantially faster than a conventional example. But as the width w of the first gap 211d and the second gap 212d increases, the amount of active material in the first electrode plate 211 and the second electrode plate 212 decreases. And when the width w of the first gap 211d and the second gap 212d exceeds 0.5 mm, the capacity of the first electrode plate 211 and the second electrode plate 212 may be too low.

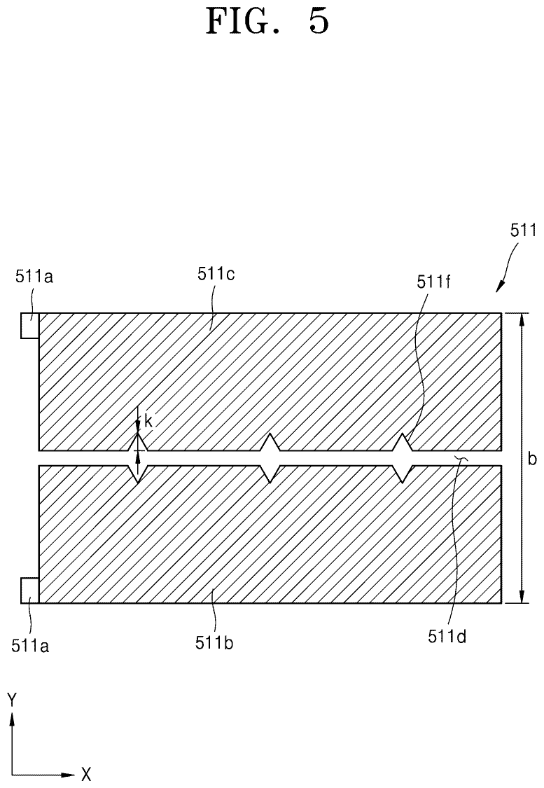

FIG. 5 is a cross-sectional view of another example of a cross-section of the first electrode plate of the battery depicted in FIG. 1.

Referring to FIG. 5, a battery cell according to another embodiment of the present disclosure may include a first electrode plate 511 and a second electrode plate facing the first electrode plate 511. The shape of the second plate may be the same as that of the first plate 51 depicted in FIG. 5.

The first electrode plate 511 may include a first region 511b and a second region 511c that are spaced apart from each other. In some embodiments, a first gap 511d into which an electrolyte permeates is formed between the first region 511b and the second region 511c. That is, the electrolyte may permeate through the first gap 511d formed between the first region 511b and the second region 511c. Grooves 511f are formed into the first region 511b or the second region 511c from the first gap 511d. As described above, the electrolyte may permeate into the electrode assembly through the first gap 511d and a gap between the case and the first electrode plate 511. When the first region 511b and the second region 511c include grooves 511f, the electrolyte may also permeate into the electrode assembly through the grooves 511f. That is, the electrolyte may quickly permeate into a central portion of the first region 511b and the second region 511c which are relatively far from the first gap 511d and the gap between the case and the first electrode plate 511. As a result, the time required for the electrolyte injection process may be shortened, thereby speed of production of battery cells. And the performance of the battery cell may be improved by evenly permeating the electrolyte throughout the overall area of the electrode assembly.

In some embodiments, a ratio of a width k of the groove 511f to a length b of a shorter side of the first electrode plate 511 may be 0.125 to 0.375. When the ratio of the width k of the groove 511f to the length b of the shorter side of the first electrode plate 511 is 0.125 or more, the electrolyte may permeate more effectively into the center portion of the first region 511b and the second region 511c. However, if the ratio of the width k of the groove 511f to the length b of the shorter side of the first electrode plate 511 exceeds 0.375, the amount of the first active material in the first electrode plate 511 may be decreased such that the capacity of the first electrode plate 511 is substantially reduced.

The overall area of the groove 511f may be designed with consideration of the capacity of the first electrode plate 511 and the time of the electrolyte injection process. In FIG. 5, the shape of the groove 511f is illustrated as a triangle. But the shape of the groove 511f is not limited in the present disclosure and may include various shapes such as a round shape and a square shape.

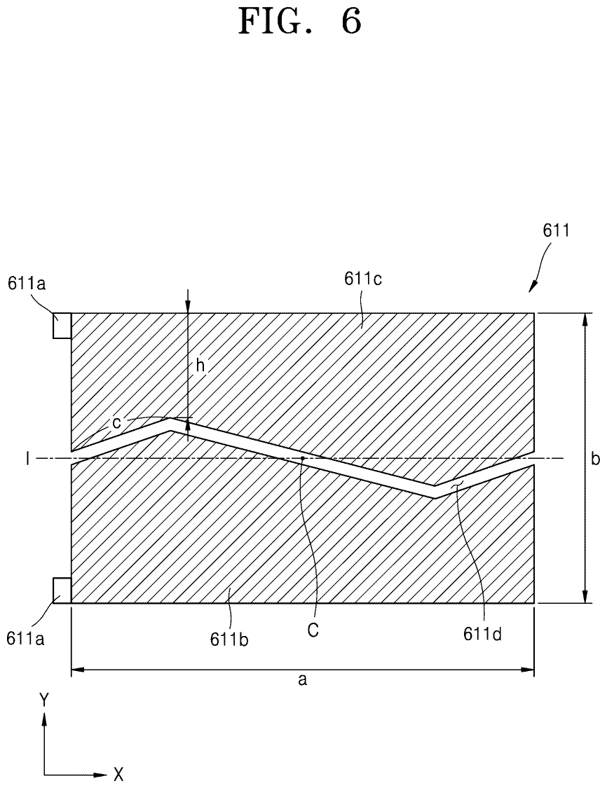

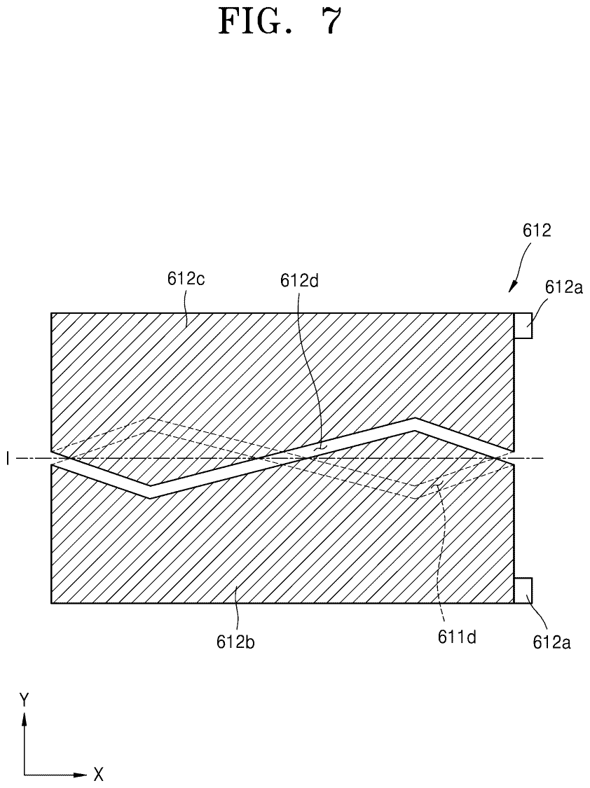

FIG. 6 is a cross-sectional of another example of a cross-section of the first electrode plate of the battery depicted in FIG. 1, and FIG. 7 is a cross-sectional view schematically illustrating another example of a cross-section of the second electrode plate of the battery depicted in FIG. 1.

Referring to FIGS. 6 and 7, a battery cell according to another embodiment of the present disclosure may include a first electrode plate 611 and a second electrode plate 612 facing the first electrode plate 611. The first electrode plate 611 may include a first region 611b and a second region 611c that are spaced apart from each other. An electrolyte may permeate a first gap 611d formed between the first region 611b and the second region 611c. The second electrode plate 612 may include a third region 612b and a fourth region 612c that are spaced apart from each other. An electrolyte may permeate a second gap 612d formed between the third region 612b and the fourth region 612c.

The first gap 611d has a zigzag shape and may extend along a first direction x. In some embodiments, a shape of the first gap 611d may be point-symmetrical with respect to the center C of the first electrode plate 611 along the first direction x.

The shape of the second electrode plate 612 may be a shape that is 180° rotated relative to the first electrode plate 611. That is, referring to FIG. 7, the first gap 611d and the second gap 612d may be symmetric to each other with respect to an imaginary line l passing through the center of the first electrode plate 611 along the first direction x.

As described above, the electrolyte may permeate into the electrode assembly through the first gap 611d and the second gap 612d, a gap between a case and the first electrode plate 611, and a gap between the case and the second electrode plate 612. When the first gap 611d has a zigzag shape, and the shape of the second electrode plate 612 is a shape that is obtained by rotating the first electrode plate 611 by 180°, the electrolyte may quickly and evenly permeate into center portions of the first region 611b, the second region 611c, the third region 612b, and the fourth region 612c. As a result, the time required for the electrolyte injection process may be shortened, thereby improving the production speed of battery cells. Further, the performance of the battery cells may be improved due to the electrolyte evenly permeating throughout the electrode assembly.

In some embodiments, the ratio of the total length of the first gap 611d to a length a of a longer side of the first electrode plate 611 along the first direction x may be 1.1 to 1.5. When the ratio of the total length of the first gap 611d to the length a of the longer side of the first electrode plate 611 is 1.1 or more, the electrolyte may permeate more effectively to the center portions of the first region 611b and the second region 611c. However, if the ratio of the total length of the first gap 611d to the length a of the longer side of the first electrode plate 611 exceeds 1.5, the amount of first active material in the first electrode plate 611 may be so reduced that the capacity of the first electrode plate 611 is too low.

The ratio of the shortest width of the first region 611b along the second direction y to the length of a shorter side b of the first electrode plate 611 along the second direction y perpendicular to the first direction x may be 0.125 to 0.375, and the ratio of the shortest width of the second region 611c to the length of the shorter side b of the first electrode plate 611 may be 0.125 to 0.375. When the ratio of the shortest width of the first region 611b and the second region 611c to the length of the shorter side b of the first electrode plate 611 is 0.125 or more, the electrolyte may effectively permeate into the center portions of the first region 611b and the second region 611c. If the ratio of the shortest width of the first region 611b and the second region 611c to the length of the shorter side b of the first electrode plate 611 exceeds 0.375, then electrolyte injection process time may increase.

Although the shape of the first gap 611d in FIGS. 6 and 7 is illustrated as an angular zigzag shape, the present disclosure is not limited thereto. The shape of the first gap 611d may be varied so long as the shape allows an electrolyte to evenly permeate into the entire electrode assembly. In another example, the first gap 611 has a sine function shape.

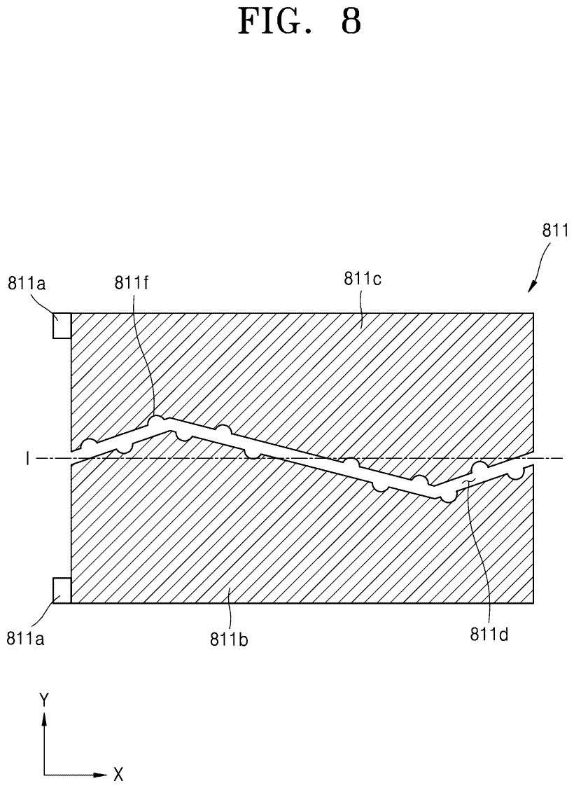

FIG. 8 is a cross-sectional view of another example of a cross-section of the first electrode plate of FIG. 1.

Referring to FIG. 8, a battery cell according to another embodiment of the present disclosure may include a first electrode plate 811 and a second electrode plate facing the first electrode plate 811. The shape of the second electrode plate may be the same as shape of the first electrode plate rotated by 180°.

The first electrode plate 811 may include a first region 811b and a second region 811c that are spaced apart from each other. An electrolyte may permeate into a first gap 811d formed between the first region 811b and the second region 811c. The first region 811b and the second region 811c may include grooves 811f from the first gap 811d into the first and second regions 811b and 812c.

The first gap 811d may extend along a first direction x, and the first gap 811d may have a zigzag shape in a second direction y perpendicular to the first direction x. In some embodiments, a shape of the first gap 811d may be point-symmetrical with respect to a center of the first electrode plate 811.

The ratio of the total length of the first gap 811d to the length of the longer sides of the first electrode plate 811 and the ratio of the shortest widths of the first region 811b and the second region 811c to the length of the shorter sides of the first electrode plate 811 may be the same as the ratios illustrated and described above with reference to FIG. 7.

As described above, an electrolyte may permeate into the electrode assembly through the first gap 811d and a gap between a case and the first electrode plate 811. In a case where the first gap 811d extends along the first direction x, the first gap 811d has a zigzag shape in in the second direction y perpendicular to the first direction x, and the first region 811b and the second region 811c include grooves 811f. With such a configuration, the electrolyte can quickly and evenly permeate the entire region of the electrode assembly. Thus, the time required for an electrolyte injection process may be shortened, thereby improving the speed that the battery cells can be produced. Further, the performance of battery cells may be improved by the electrolyte evenly permeating throughout the entire area of the electrode assembly.

The total area of the grooves 811f may be determined and made by comparing the capacity of the first electrode plate 811 and the time required for the electrolyte injection process. Although the shape of the grooves 811f in FIG. 8 is illustrated as a round shape, the shape of the grooves 811f is not limited thereto. The shape of the grooves 811f may be of various other shapes as long as the shape allows an electrolyte to evenly penetrate into the entire electrode assembly.

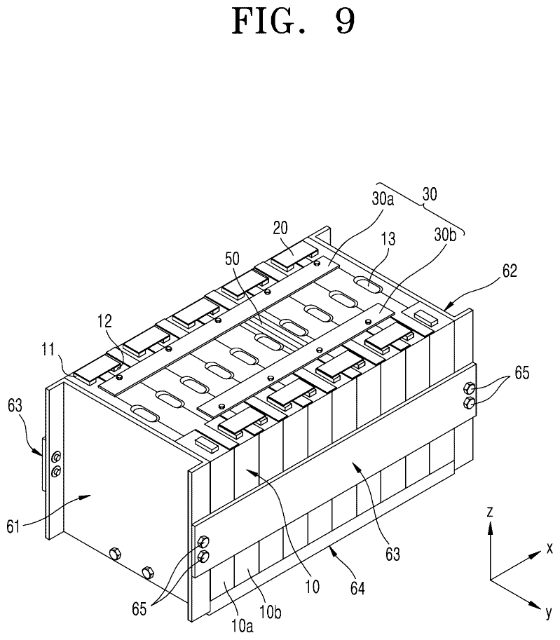

FIG. 9 is a perspective view of a battery module including a battery cell according to embodiments of the present disclosure.

Referring to FIG. 9, a battery module 100 according to an embodiment of the present disclosure may include terminal portions 11 and 12 including a first terminal 11 and a second terminal 12. A plurality of battery cells 10 are arranged in one direction, and a connection tab 20 connecting one battery cell 10a to another battery cell 10b is provided. A protection circuit module 30 has one end portion connected to the connection tab 20. The battery cell 10 may any of the battery cells illustrated and described above with respect to FIGS. 1 to 8.

In an embodiment, the protection circuit module 30 may be, for example, a battery management system (BMS). The connection tab 20 may include a body portion that contacts the terminal portions 11 and 12 between the battery cells 10a and 10b that adjacent to each other and an extension portion that extends from the body portion and is connected to the protection circuit module 30. The connection tab 20 may be a bus bar.

One side of each of the battery cells 10 may be provided with the terminal portions 11 and 12 electrically connected to the connection tab 20 and a vent 13 that is a passage for discharging gas generated in the battery cell. The terminals 11 and 12 of each battery cell 10 may be a first terminal 11 and a second terminal 12 having different polarities. In some embodiments the first terminal 11 is a positive electrode terminal and the second terminal 12 is a negative electrode terminal. Conversely the first terminal 11 is a negative electrode terminal and the second terminal 12 is a positive electrode terminal. That is, the first terminal 11 and the second terminal 12 are formed with different polarities and are not limited to a specific polarity.

The terminals 11 and 12 of the battery cell 10, that are adjacent to each other may be electrically connected in series and/or in parallel due by the connection tab 20. In an embodiment, a first terminal 11 of one battery cell 10 may be electrically connected to a second terminal 12 of another battery cell 10 adjacent thereto through a connection tab 20, and a second terminal 12 of the one battery cell 10 may be electrically connected to a first terminal 11 of another battery cell 10 adjacent thereto through another connection tab 20.

In some embodiments, although a serial connection is described as an example in FIG. 9, the present disclosure is not limited to such a structure and various connection structures may be adopted as needed. The number and arrangement of battery cells are not limited to the structure illustrated in FIG. 9.

A plurality of battery cells 10 may be arranged in one direction so that the wide surfaces of the battery cells 10 face each other, and the arranged plurality of battery cells 10 may be accommodated by housings 61, 62, 63, and 64. The housings 61, 62, 63, and 64 may include a pair of end plates 61 and 62 facing wide surfaces of the battery cell 10, a side plate 63 connecting the pair of end plates 61 and 62, and a bottom plate 64.

The side plate 63 may support a side of the battery cells 10, and the bottom plate 64 may support a bottom surface of the battery cells 10. In some embodiments, each of the pair of end plates 61 and 62, the side plate 63 and the bottom plate 64 may be connected by a structure such as a bolt 65. However, the present disclosure is not limited thereto, and the pair of end plates 61 and 62, the side plate 63, and the bottom plate 64 may be fastened by other means.

A protection circuit module 30 may mount electronic components, protection circuits, or the like, and may be electrically connected to the connection tab 20 described below. The protection circuit module 30 may include a first protection circuit module 30a and a second protection circuit module 30b that extend from different positions along the direction that the plurality of battery cells 10 are arranged. The first protection circuit module 30a and the second protection circuit module 30b are spaced apart from each other by a certain distance and positioned parallel to each other so that they may each be electrically connected to connection tabs 20.

The first protection circuit module 30a is formed to extend on one side of an upper portion of each of the plurality of battery cells 10 along the direction that the plurality of battery cells 10 are arranged, and the second protection circuit module 30b is formed to extend on the other side of the upper portion of each of the plurality of battery cells 10 along the direction that the plurality of battery cells 10 are arranged. The second protection circuit module 30b is spaced apart from the first protection circuit module 30a by a certain distance with the vent 13 interposed therebetween. The second protection circuit module 30b may be arranged parallel to the first protection circuit module 30a. As such, two protection circuit modules 30a and 30b are arranged parallel and spaced apart from each other along one direction in which a plurality of battery cells are arranged, thereby minimizing the area of a printed circuit board (PCB) constituting a protection circuit module 30. The protection circuit module 30 is configured separate from two protection circuit modules 30a and 30b to minimize unnecessary area of the PCM.

The first protection circuit module 30a and the second protection circuit module 30b may be connected to each other by a conductive connection member 50. One side of the connection member 50 is connected to the first protection circuit module 30a and the other side thereof is connected to the second protection circuit module 30b so that an electrical connection is made between the two protection circuit modules 30a and 30b. The connection may be made by any one of soldering, resistance welding, laser welding or projection welding methods.

The connection member 50 may be elastic or flexible. With such a connection member 50, the voltage, temperature, and current of a plurality of battery cells 10 may be checked and managed to ensure they are normal. That is, information about voltage, current, temperature, or the like received by the first protection circuit module 30a from the connection taps 20 adjacent thereto and information about voltage, current, temperature, or the like received by the second protection circuit module 30b from the connection taps 20 adjacent thereto may be integrally managed by the protection circuit module 30 through the connection member.

In an event where the battery cell 10 swells, impacts may be absorbed by the elasticity or flexibility of the connection member 50, thereby preventing the first protection circuit module 30a and the second protection circuit module 30b from being damaged. The shape and structure of the connection member 50 are not limited to the shape shown in FIG. 9.

Because the protection circuit module 30 is provided with the first protection circuit module 30a and the second protection circuit module 30b, the area of the PCB configuring the protection circuit module 30 may be minimized, thereby providing for space inside a battery module 100. This may facilitate repairs when an abnormality is detected in the battery module 100 and also connecting a connection tab 20 and a protection circuit module 30.

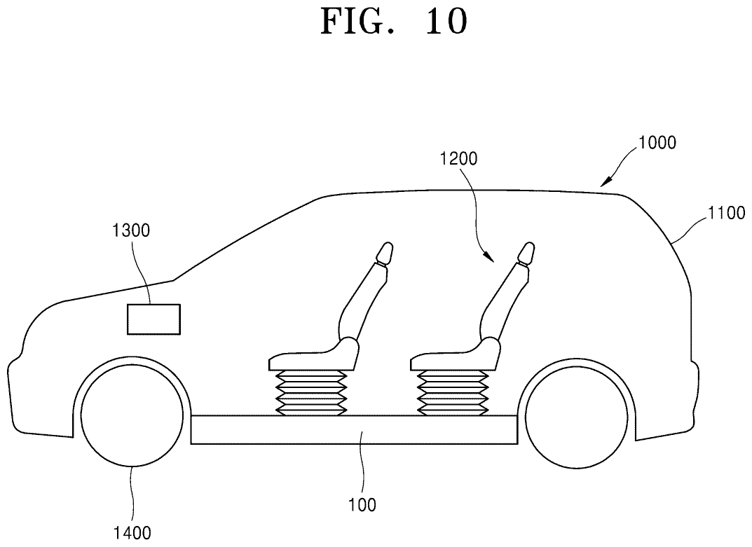

FIG. 10 is a cross-sectional view of a means of transportation including a battery cell according to embodiments of the present disclosure.

Referring to FIG. 10, a means of transportation 1000 (e.g., a car, truck, etc.) may include a body 1100, a seat 1200 arranged on the body 1100, a battery module 100 accommodating a plurality of battery cells, a motor 1300 generating driving force for the means of transportation 1000, and a driving wheel 1400 mounted on the body 1100. The battery cells may be any of those illustrated and described above with reference to FIGS. 1 to 8, and the battery module 100 may be the battery module illustrated and described above with reference to FIG. 9.

According to embodiments of the present disclosure, an electrolyte rapidly permeate an electrode assembly, thereby shortening the time for an electrolyte injection process and increasing the speed battery cells can be produce. The electrolyte may evenly permeate the entire area of the electrode assembly, thereby improving the performance of the battery cells.

The effects obtainable through the present disclosure are not limited to the effects described above, and other technical effects not mentioned will be clearly understood by those skilled in the art from the description.

Although the present disclosure has been described above with reference to limited embodiments and drawings, the present disclosure is not limited thereto, and it is obvious that various modifications and variations are possible within the scope of the technical idea of the present disclosure.

What is claimed is:

1. A battery cell comprising:
a first electrode plate;
a second electrode plate facing the first electrode plate;
a separator positioned between the first electrode plate and the second electrode plate;
a case accommodating the first electrode plate, the second electrode plate and the separator; and
an electrolyte provided in the case,
wherein the first electrode plate includes a first region and a second region that are spaced apart from each other, and
wherein a gap into which the electrolyte permeates is formed between the first region and the second region, with a width of the gap being 0.1 mm to 0.5 mm.

2. The battery cell of claim 1, wherein a shape of the second electrode plate is the same as a shape of the first electrode plate rotated by 180°.

3. The battery cell of claim 1, wherein the first region and the second region each include a non-coated portion.

4. The battery cell of claim 1, wherein the second electrode plate includes a third region and a fourth region that are spaced apart from each other, and a gap into which the electrolyte permeates is formed between the third region and the fourth region.

5. The battery cell of claim 1, wherein the first region includes a groove extending from the gap into the first region and the second region includes a groove extending from the gap into the second region.

6. The battery cell of claim 5, wherein a ratio of a width of each of the grooves to a length of a shorter side of the first electrode plate is 0.125 to 0.375.

7. The battery cell of claim 1, wherein the gap has a zigzag shape and extends.

8. The battery cell of claim 7, wherein the gap extends along a first direction, and
wherein a ratio of the shortest width of the first region along a second direction perpendicular to the first direction to a length of a shorter side of the first electrode plate along the second direction is 0.125 to 0.375.

9. The battery cell of claim 7, wherein the gap extends along a first direction, and
wherein a ratio of a total length of the gap to a length of a longer side of the first electrode plate along the first direction is 1.1 to 1.5.

10. The battery cell of claim 4, wherein the gap in the first electrode plate and the gap in the second electrode plate are symmetric to each other with respect to an imaginary line passing through a center of the first electrode plate along a direction that the gaps extend.

11. A battery cell comprising:
a first electrode plate including a first region and a second region that are spaced apart from each other,
a second electrode plate facing the first electrode plate and including a third region and a fourth region that are spaced apart from each other,
a separator positioned between the first electrode plate and the second electrode plate, and
a case accommodating the first electrode plate, the second electrode plate and the separator and an electrolyte,
wherein a shape of the second electrode plate is the same as the first electrode plate rotated by 180°.

12. The battery cell of claim 11, wherein the electrolyte permeates a first gap between the first region and the second region and a second gap between the third region and the fourth region.

13. The battery cell of claim 12, wherein the first gap extends along a first direction and the second gap extends along the first direction.

14. The battery cell of claim 13, wherein the first gap has a zigzag shape.

15. The battery cell of claim 14, wherein the first region includes a groove extending from the first gap into the first region and the second region includes a groove extending from first gap into the second region.

16. The battery cell of claim 14, wherein a ratio of a total length of the first gap to a length of a longer side of the first electrode plate along the first direction is 1.1 to 1.5.

17. The battery cell of claim 14, wherein a ratio of a shortest width of the first region along a second direction perpendicular to the first direction to a length of a shorter side of the first electrode plate along the second direction is 0.125 to 0.375.

18. The battery cell of claim 11, wherein the first region and the second region each include a groove extending from the first gap into the regions, and a ratio of a width of the groove to a length of a shorter side of the first electrode plate is 0.125 to 0.375.

19. The battery cell of claim 11, wherein the first region and the second region each include a non-coated portion.

20. The battery cell of claim 11, wherein a width of the first gap is 0.1 mm to 0.5 mm.
